(19) United States
(12) Patent Application Publication
(10) Pub. No.: US 2026/0249793 A1
(43) Pub. Date: Aug. 27, 2026

(54) PROTECTOR AND WIRING HARNESS ROUTING STRUCTURE

(71) Applicant: SUMITOMO WIRING SYSTEMS, LTD., Mie (JP)

(72) Inventor: Yusuke ANDO, Mie (JP)

(21) Appl. No.: 19/539,566

(22) Filed: Feb. 13, 2026

(30) Foreign Application Priority Data
Feb. 21, 2025 (JP) 2025-027316

(51) Int. Cl. B60R 16/02; H02G 3/04

(52) U.S. Cl. CPC B60R 16/0215; H02G 3/0418

(57) ABSTRACT

A protector includes a duct-like storage space in which the wiring harness is disposed, and includes a bottom surface part, a top surface part, and a lateral surface part that form the storage space. The storage space includes a first space in which a connector of the wiring harness is disposed, and a second space into which a wire that connects to the connector is inserted. The bottom surface part forming the first space includes a rail with which the connector is engaged in a slidable manner. The top surface part forming the first space includes a rib provided to approach an outer peripheral surface of the connector disposed in the first space.

### CROSS-REFERENCE TO RELATED APPLICATIONS

This application is based on and claims priority from Japanese Patent Application No. 2025-027316, filed on Feb. 21, 2025, with the Japan Patent Office, the disclosure of which is incorporated herein in its entirety by reference.

### TECHNICAL FIELD

The present disclosure relates to a protector and a routing structure for a wiring harness.

### BACKGROUND

JP 2021-078168 A discloses a protector that protects a wiring harness installed in a vehicle such as an automobile. Routing material constituting the wiring harness can be protected from constituent members of the vehicle and the like by attaching a protector to the routing material. The routing material is, for example, a wire with connector having a connector at an end portion of the wire.

### SUMMARY

A connector provided in a wiring harness protected by a protector is, for example, connected to another connector provided in another wiring harness. If the connection point between the two connectors is not fixed to an immovable member, high stress could possibly act on the connection point between the two connectors due to vibration during vehicle use and the like. When high stress acts on the connection point, issues such as the two connectors becoming disconnected or the wire being cut at the position of the connector could possibly arise.

One object of the present disclosure is to provide a protector in which the connection point where a connector of a wiring harness protected by the protector is connected to another connector is not prone to high stress acting thereon. Another object of the present disclosure is to provide a routing structure for a wiring harness that includes the protector.

A protector of the present disclosure is a protector provided with a duct-like storage space in which a wiring harness is to be disposed, and includes a bottom surface part, a top surface part, and a lateral surface part that form the storage space. The storage space includes a first space in which a connector of the wiring harness is to be disposed and a second space into which a wire that connects to the connector is to be inserted. The bottom surface part forming the first space includes a rail with which the connector is to be engaged in a slidable manner. The top surface part forming the first space includes a rib provided to approach an outer peripheral surface of the connector that is disposed in the first space.

According to the protector of the present disclosure, the connection point where a connector of a wiring harness protected by the protector is connected to another connector is not prone to high stress acting thereon.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic perspective view of a routing structure for a wiring harness according to an embodiment.

FIG. 2 is an exploded perspective view of the wiring harness routing structure according to the embodiment.

FIG. 3 is an enlarged perspective view of the vicinity of a first space in FIG. 2.

FIG. 4 is a cross-sectional view taken along line IV-IV in FIG. 3.

FIG. 5 is an enlarged perspective view showing part of the first space of a protector according to the embodiment.

FIG. 6 is an enlarged perspective view showing the vicinity of a lid of the protector according to the embodiment.

FIG. 7 is a cross-sectional view taken along line VII-VII in FIG. 1.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Disclosure

First, embodiments of the present disclosure will be enumerated and described.

[1] A protector of the present disclosure is a protector provided with a duct-like storage space in which a wiring harness is to be disposed, and includes a bottom surface part, a top surface part, and a lateral surface part that form the storage space. The storage space includes a first space in which a connector of the wiring harness is to be disposed and a second space into which a wire that connects to the connector is to be inserted. The bottom surface part forming the first space includes a rail with which the connector is to be engaged in a slidable manner. The top surface part forming the first space includes a rib provided to approach an outer peripheral surface of the connector that is disposed in the first space.

"Approach" as referred to herein means "comes in contact with" or having a clearance of 1 mm or less.

With the protector according to <1> above, the connector of the wiring harness can be engaged in a slidable manner with the rail provided on the bottom surface part that forms the first space, and thus the connector is fixed to the protector. Also, the connector disposed in the first space is not prone to looseness, due to the rib disposed on the top surface part that forms the first space approaching the outer peripheral surface of the connector. Thus, even if another wiring harness is pulled during manufacture of the vehicle or the vehicle vibrates during use of the vehicle, the connector is unlikely to drop out of the protector and the state in which the connector is held by the protector is readily maintained. If the connector is held by the protector, the connection point between the connector and another connector is not prone to high stress acting thereon due to vibration during use of the vehicle or the like.

[2] In the protector according to [1] above, the first space may have an opening that opens externally, and the rib may include a first rib disposed in a vicinity of the second space and a second rib disposed at a position closer to the opening than is the first rib.

The end portion of the connector can be prevented from rotating toward the bottom surface part by the first rib. The end portion of the connector can be prevented from rotating toward the top surface part by the second rib. Accordingly, the connector disposed in the first space is not prone to looseness.

[3] In the protector according to [1] or [2] above, the bottom surface part forming the first space may include a stopper part provided to approach the outer peripheral surface of the connector that is disposed in the first space.

The connector is prevented from rotating toward the top surface part by the stopper part. Thus, the connector disposed in the first space is not prone to looseness.

[4] The protector according to any of [1] to [3] above may further include a main body constituted by the bottom surface part and the lateral surface part, and a cover constituted by the top surface part and forming the second space, and the cover may be attachable and detachable with respect to the main body.

Due to the cover being attachable and detachable with respect to the main body, the wires can be disposed in the second space of the main body in a state where the cover constituting the top surface part is removed. Thus, since the top surface part does not interfere with disposition of the wires into the second space, the wires are easily disposed in the second space.

[5] The protector according to [4] above may further include a first engaging part having a snap-fit structure and configured to engage the main body and the cover with each other.

With the first engaging part having a snap-fit structure, the main body and the cover can be securely engaged with each other, and the cover is unlikely to separate from the main body merely due to vibration of the vehicle. On the other hand, if a jig suitable for releasing engagement by the snap-fit structure is used, engagement between the main body and the cover by the first engaging part can be easily released.

[6] The protector according to [4] or [5] above may further include a lid constituted by the top surface part and forming the first space, and the lid may be connected to the main body by a hinge part and be openable and closeable with respect to the main body.

Due to the lid being openable and closeable with respect to the main body with the hinge part as the rotation axis, the connector can be engaged with the rail in a state where the lid constituting the top surface part is open. Thus, since the top surface part does not interfere with engagement of the connector with the rail, the connector is easily disposed in the first space. Also, if the lid is attached to the main body by the hinge part, the main body and the lid can be molded with a single mold.

[7] The protector according to [6] above may further include a second engaging part having a snap-fit structure and configured to engage the main body and an end portion of the lid on an opposite side to the hinge part with each other.

According to the second engaging part having a snap-fit structure, the main body and the lid can be securely engaged with each other, and the lid is unlikely to open merely due to vibration of the vehicle. On the other hand, if a jig suitable for releasing engagement of the snap-fit structure is used, engagement of the lid and the main body by the second engaging part can be easily released.

[8] A wiring harness routing structure according to an embodiment includes a wiring harness and a protector including a duct-like storage space in which the wiring harness is disposed. The protector includes a bottom surface part, a top surface part, and a lateral surface part that form the storage space. The storage space includes a first space in which a connector of the wiring harness is disposed and a second space into which a wire that connects to the connector is inserted. The bottom surface part forming the first space includes a rail with which the connector is engaged in a slidable manner. The top surface part forming the first space includes a rib provided to approach an outer peripheral surface of the connector disposed in the first space.

With the routing structure for the wiring harness according to <8> above, the connector is fixed to the protector due to the connector of the wiring harness being engaged in a slidable manner with the rail provided on the bottom surface part forming the first space. Also, the rib disposed on the top surface part that forms the first space approaches the outer peripheral surface of the connector, and thus the connector disposed in the first space is not prone to looseness. Thus, even if another wiring harness is pulled during manufacture of the vehicle or the vehicle vibrates during use of the vehicle, the connector is unlikely to drop out of the protector and the state in which the connector is held by the protector is readily maintained. If the connector is held by the protector, high stress is unlikely to act on the connection point between the connector and another connector due to vibration during vehicle use or the like, for example.

### Detailed Description of Embodiments of the Disclosure

Hereinafter, embodiments of a protector and a routing structure for a wiring harness of the present disclosure will be described based on the drawings. The same reference signs in the diagrams indicate constituent elements of the same name. Note that the present invention is not limited to the configurations shown in the embodiments and is indicated by the claims, and all changes that come within the meaning and range of equivalency of the claims are intended to be embraced therein.

### First Embodiment

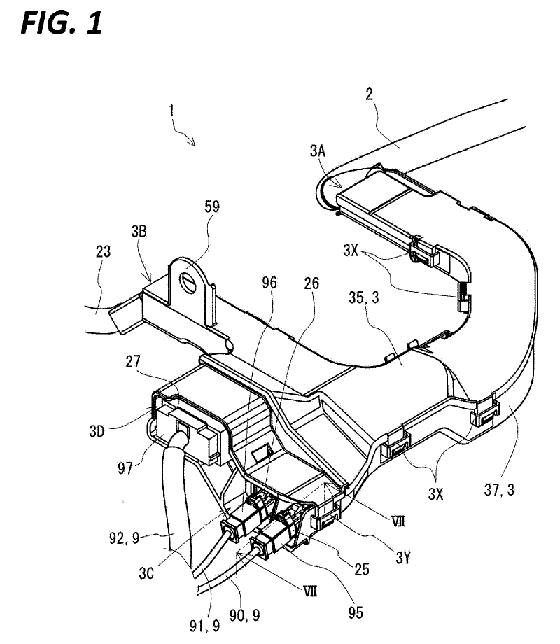

A routing structure 1 for a wiring harness shown in FIG. 1 is provided with a wiring harness 2 and a protector 3 that are installed in a vehicle. One of the characteristics of the wiring harness routing structure 1 of the present example is that connectors 25 and 26 of the wiring harness 2 are fixed to the protector 3 so as to prevent looseness. Hereinafter, the wiring harness routing structure 1 will simply be referred to as the routing structure 1, and configurations of the routing structure 1 will be described.

### Wiring Harness

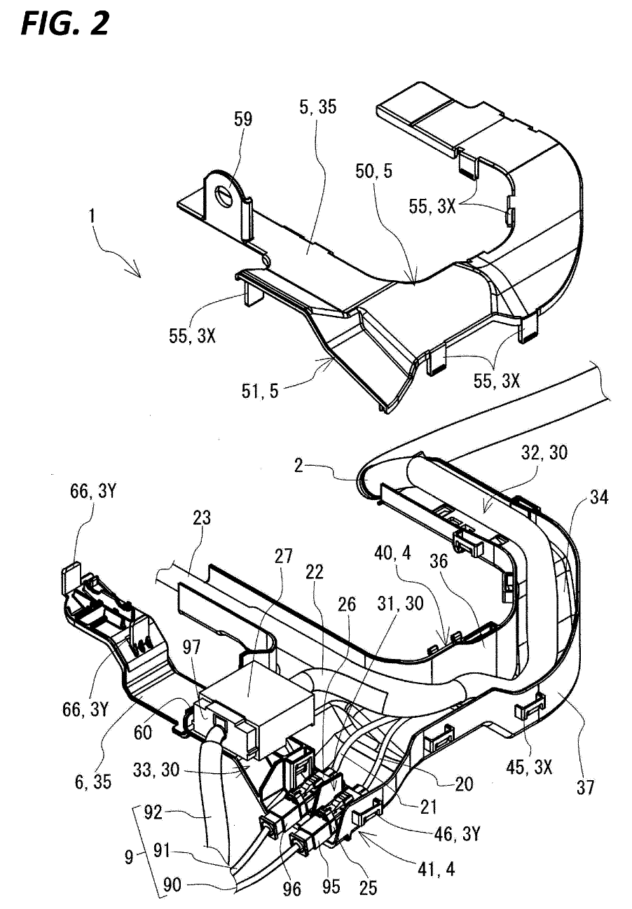

As shown in the exploded perspective view of FIG. 2, the wiring harness 2 is a wiring member in which a plurality of wires 20, 21, 22, and 23 are bound together with tape or the like. The wiring harness 2 of the present example is provided with two small diameter wires 20 and 21 and two large diameter wires 22 and 23. In the present example, the four wires 20, 21, 22, and 23 branch out in a storage space 30 formed inside the protector 3. The connectors 25 and 26 are attached to end portions of the small diameter wires 20 and 21. A connector 27 is attached to an end portion of the large diameter wire 22. The end portion of the large diameter wire 23 is not illustrated.

Connectors 95, 96, and 97 that are provided in another wiring harness 9 are connected to the connectors 25, 26, and 27. The other wiring harness 9 is a wiring member in which a plurality of wires 90, 91, and 92 provided with the connectors 95, 96, and 97 are bound together.

The connectors 25, 26, and 27 are fixed to the protector 3 which will be described later. The connectors 25 and 26 are smaller than the connector 27, and are difficult to stably fix to the protector 3. The connectors 25 and 26 have the same structure as each other. The protector 3 of the present example is configured to stabilize the fixed state of the relatively small connectors 25 and 26, as will be described later.

### Protector

The protector 3 is, for example, formed with an insulating material such as resin. The protector 3 is, for example, manufactured by resin molding. The resin is, for example, polyethylene terephthalate resin or the like. The resin may contain an insulating filler or the like.

The protector 3 is provided with the storage space 30, which is a duct-like space in which the wiring harness 2 is disposed. The storage space 30 is provided with a first space 31 in which the small connectors 25 and 26 of the wiring harness 2 are disposed, and a second space 32 in which the wires 20, 21, 22, and 23 are disposed. Furthermore, the protector 3 of the present example is provided with a third space 33 in which the large connector 27 of the wiring harness 2 is disposed. The first space 31, the second space 32, and the third space 33 are connected to each other.

The second space 32 is an approximately U-shaped space, and both end portions of the U-shape open toward the upper left in FIGS. 1 and 2. These two end portions form openings 3A and 3B of the protector 3, as shown in FIG. 1. The opening 3A is a hole for leading the wiring harness 2 out from inside the protector 3. The opening 3B is a hole for leading the wire 23 of the wiring harness 2 out from inside the protector 3.

The first space 31 and the third space 33 shown in FIG. 2 branch from the vicinity of the bend portion of the U-shape of the second space 32. The end portions of the first space 31 and the third space 33 on the opposite side to the portions connected to the second space 32 open toward the lower left in FIGS. 1 and 2. These end portions of the first space 31 and the third space 33 respectively form an opening 3C and an opening 3D of the protector 3, as shown in FIG. 1. The opening 3C is a hole that exposes the end portions of the connectors 25 and 26 to outside of the protector 3. Exposing the connectors 25 and 26 through the opening 3C allows the connectors 25 and 26 to be connected to the other connectors 95 and 96. Also, the opening 3D is a hole that exposes the end portion of the connector 27 to outside of the protector 3. Exposing the connector 27 through the opening 3D allows the connector 27 to be connected to the other connector 97.

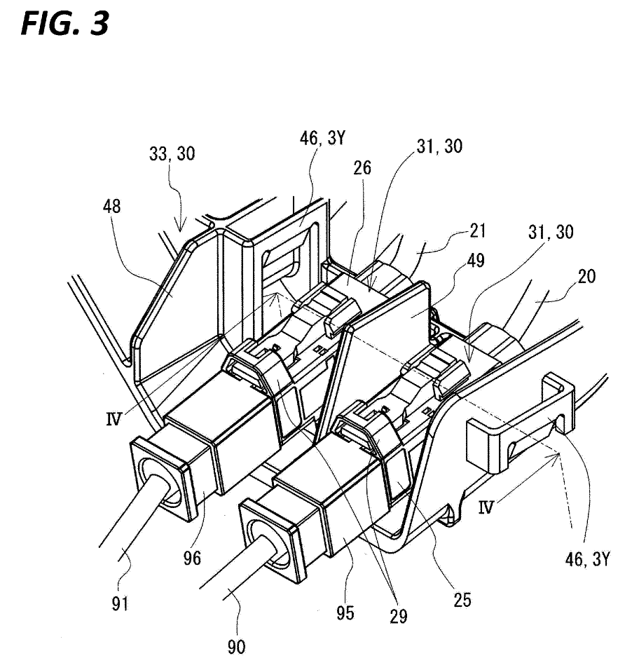

The connection between the connector 25 and the other connector 95 and the connection between the connector 26 and the other connector 96 are maintained by a locking mechanism 29 shown in FIG. 3. The locking mechanism 29 is a known configuration in which the two connectors 25 and 95 or the two connectors 26 and 96 are connected to each other by mechanical fitting, and a detailed description thereof is omitted herein. As already mentioned, the relatively small connectors 25 and 26 are more prone to looseness than the larger connector 27. The connections of the connectors 25 and 26 with the other connectors 95 and 96 could possibly be disconnected when excessive stress is applied to the locking mechanism 29. Thus, preventing looseness of the connectors 25 and 26 and preventing the connectors 25 and 26 from dropping out of the protector 3 contributes to maintaining the connections of the connectors 25 and 26 with the other connectors 95 and 96.

As shown in FIG. 2, the protector 3 is provided with a bottom surface part 34, a top surface part 35, and lateral surface parts 36 and 37 that form the storage space 30. The bottom surface part 34 is a portion that is disposed downward in the vehicle. The top surface part 35 is a portion that is disposed upward in the vehicle and faces the bottom surface part 34. The lateral surface parts 36 and 37 are wall parts that connect the bottom surface part 34 to the top surface part 35. The protector 3 provided with the bottom surface part 34, the top surface part 35, and the lateral surface parts 36 and 37 is constituted by combining a plurality of members. The plurality of members in the present example are a main body 4, a cover 5, and a lid 6.

### Main Body

The main body 4 is constituted by the bottom surface part 34 and the lateral surface parts 36 and 37. The main body 4 is provided with a drainpipe-shaped routing part 40 that is formed to be approximately U-shaped and a gate part 41 that branches from the vicinity of the bend portion of the U-shape of the routing part 40. The routing part 40 is the portion that forms the second space 32 described above, and the portion through which the wires 20, 21, 22, and 23 are routed. The gate part 41 is the portion that forms the first space 31 and the third space 33, and the portion in which the connectors 25, 26, and 27 are disposed.

As shown in FIG. 3, the first space 31 and the third space 33 are divided by a plate-like partitioning part 48. Also, the first space 31 is divided into two spaces by a plate-like partitioning part 49. The connector 25 is disposed in one of the spaces sandwiching the partitioning part 49, and the connector 26 is disposed in the other space.

### Cover

As shown in FIG. 2, the cover 5 is constituted by the portion of the top surface part 35 that forms the second space 32. The cover 5 is provided with a main cover 50 that covers the routing part 40 of the main body 4 and an eave part 51 that covers the gate part 41 of the main body 4. The main cover 50 is a generally U-shaped plate material. A bracket part 59 is formed in the vicinity of one of the end portions of the U-shape of the main cover 50. The bracket part 59 is a plate-like piece that extends upward and has a threaded hole. The bracket part 59 is utilized when fixing the protector 3 to a frame or the like of the vehicle (not shown).

The eave part 51 is a plate material that extends outward from the vicinity of the bend part of the U-shape of the main cover 50. The portion of the eave part 51 that faces the first space 31 is substantially parallel to the bottom surface part 34 in the first space 31. The portion of the eave part 51 that faces the third space 33 slopes upward proceeding away from the main cover 50.

The cover 5 is configured to be attachable and detachable with respect to the main body 4. The cover 5 and the main body 4 are engaged with each other by a first engaging part 3X having a snap-fit structure. The first engaging part 3X of the present example is constituted by an engaging claw 55 formed on the cover 5 and an annular fastener 45 formed on the main body 4. The engaging claw 55 is provided with a plate-like part that extends toward the main body 4 and a claw part that protrudes from the outer surface of the plate-like part. The fastener 45 is formed in a square C-shape. The main body 4 and the cover 5 are engaged with each other by the claw part of the engaging claw 55 inserted into the fastener 45 hooking onto the fastener 45. As an alternative configuration to the present example, the engaging claw 55 may be formed on the main body 4 and the fastener 45 may be formed on the cover 5.

Due to the cover 5 being attachable and detachable with respect to the main body 4, the wires 20, 21, 22, and 23 can be disposed in the routing part 40 of the main body 4 which is the second space 32 in a state where the cover 5 constituting the top surface part 35 is removed. Thus, since the top surface part 35 does not interfere with disposition of the wires 20, 21, 22, and 23 into the second space 32, the wires 20, 21, 22, and 23 are easily disposed in the second space 32.

### Lid

The lid 6 is constituted by the portions of the top surface part 35 that form the first space 31 and the third space 33. The lid 6 is connected to the main body 4 by a hinge part 60 and is openable and closeable with respect to the main body 4. The hinge part 60 is formed on a lateral part of the third space 33 that is on the opposite side to the first space 31. FIG. 2 shows a state in which the lid 6 is open.

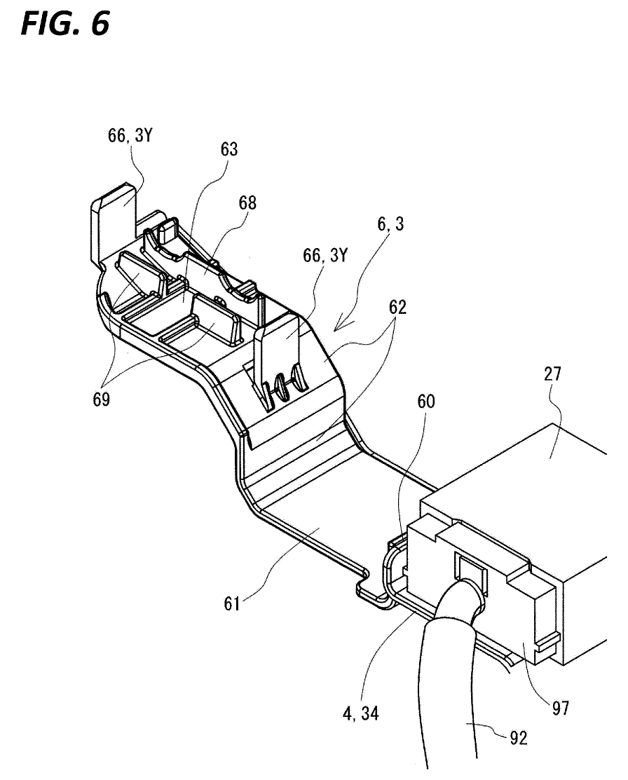

As shown in FIG. 6, the lid 6 is provided with a first portion 61, a bend part 62, and a second portion 63. Since the lid 6 is open in FIG. 6, the inner surface of the lid 6 is visible in FIG. 6. The inner surface of the lid 6 is the surface that forms the storage space 30 when the lid 6 is closed as shown in FIG. 1.

The first portion 61 of the lid 6 is connected to the hinge part 60 and is the portion that covers the connector 27 from above when the lid 6 is closed. The bend part 62 is the portion that connects the first portion 61 to the second portion 63. The bend part 62 has a generally S-shaped portion that extends obliquely from the first portion 61, then extends vertically, and then further extends obliquely. An engaging claw 66 is formed on the inner surface of the bend part 62. The engaging claw 66 constitutes part of a second engaging part 3Y, which will be described later.

The second portion 63 is the portion that covers the connectors 25 and 26 (see FIG. 1) from above when the lid 6 is closed. One first rib 68 and two second ribs 69 are formed on the inner surface of the second portion 63. Two recessed portions are formed in the distal end edge of the first rib 68. The recessed portions both face the upper surface of the connectors 25 and 26 when the lid 6 is closed. The two second ribs 69 are disposed at positions away from a first surface of the first rib 68 that faces the opening 3C (see FIG. 1). The two second ribs 69, when viewed from the opening 3C, are both disposed at positions respectively overlapping the recessed portions of the first rib 68. The second ribs 69 face the upper surface of the connectors 25 and 26 when the lid 6 is closed. These first and second ribs 68 and 69 have a function of preventing looseness of the connectors 25 and 26, as will be described later. The first and second ribs 68 and 69 also have a function of improving the mechanical strength of the lid 6.

The closed lid 6 is engaged with the main body 4 by the second engaging part 3Y which has a snap-fit structure. The second engaging part 3Y of the present example is constituted by the engaging claw 66 formed on the lid 6 and an annular fastener 46 formed on the main body 4. The engaging claw 66 is formed on the inner surface of the bend part 62 and an end portion of the second portion 63, as shown in FIG. 6. On the other hand, the fastener 46 is formed at positions that sandwich the first space 31, as shown in FIG. 3. As an alternative configuration to the present example, the engaging claw 66 may be formed on the main body 4 and the fastener 46 may be formed on the lid 6.

Due to the lid 6 being openable and closeable with respect to the main body 4, the connectors 25 and 26 can be disposed in the first space 31 in a state where the lid 6 constituting part of the top surface part 35 is open. Thus, since the top surface part 35 does not interfere with disposition of the connectors 25 and 26 into the first space 31, the connectors 25 and 26 are easily disposed in the first space 31.

If the main body 4 and the lid 6 are integrally formed by being connected by the hinge part 60, the main body 4 and the lid 6 can be molded with a single mold. In other words, there is no need to mold the main body 4 and the lid 6 with separate molds, and productivity of the protector 3 improves.

### Fixing Structure for Connector

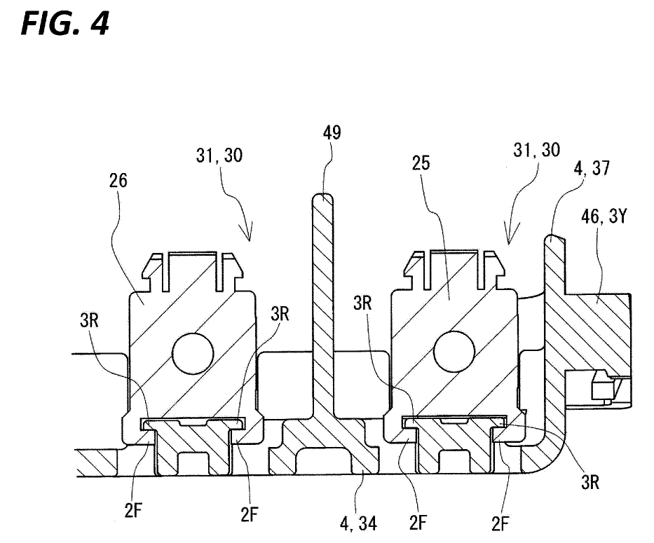

In the routing structure 1 of the present example, the small connectors 25 and 26 in the wiring harness 2 are fixed in the first space 31, and, moreover, the connectors 25 and 26 in the first space 31 are not prone to looseness. The fixing structure of the connectors 25 and 26 for achieving such a fixed state will now be described in detail based on FIGS. 4, 5, and 7. The cross-sectional view in FIG. 4 omits a detailed illustration of the internal structure of the connectors 25 and 26. Since the connectors 25 and 26 have the same structure as each other, the following description will mainly focus on the connector 25 as an example.

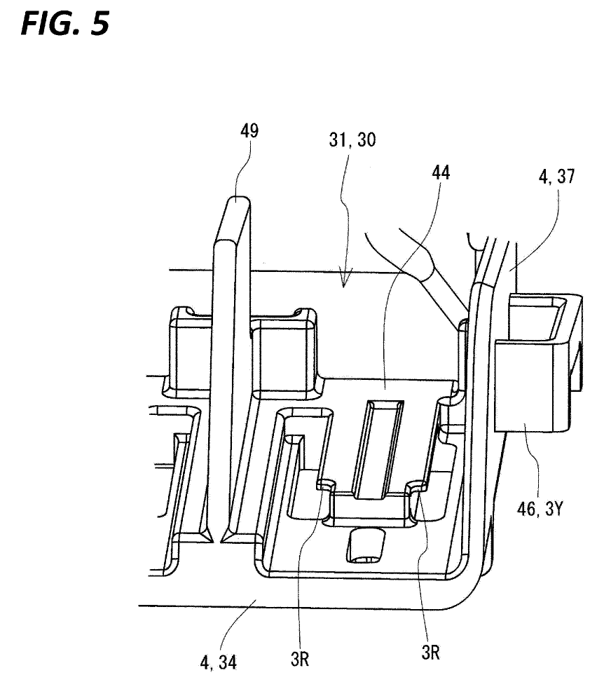

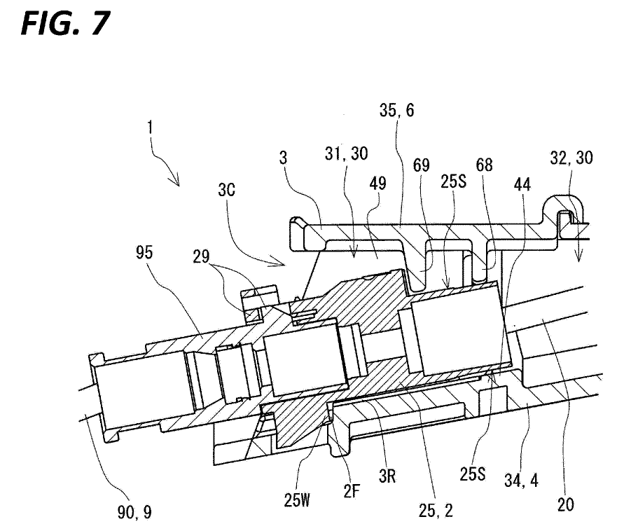

As shown in FIGS. 4 and 5, in the protector 3 of the present example, a rail 3R is formed on the bottom surface part 34 forming the first space 31. A cross-section orthogonal to a first direction along the length of the rail 3R is generally T-shaped. The rail 3R is sandwiched between two sliders 2F formed on the connector 25. A cross-section orthogonal to the length of the slider 2F on the right side in FIG. 4 is generally L-shaped. A cross-section orthogonal to the length of the slider 2F on the left side in FIG. 4 is generally reverse L-shaped. The connector 25 is engaged with the rail 3R, by sliding the connector 25 in a direction along the length of the rail 3R. Here, as shown in FIG. 7, a stepped stopper part 25W against which a distal end face of the rail 3R (see also FIG. 5) abuts is formed on the connector 25. Thus, the connector 25 is prevented from entering further than a predetermined distance into the first space 31.

As shown in the longitudinal cross-sectional view of FIG. 7, the first rib 68 and the second ribs 69 formed on the inner surface of the lid 6 approach an outer peripheral surface 25S of the connector 25 when the lid 6 is closed. More specifically, the distal ends of the first and second ribs 68 and 69 approach the upward-facing surface of the outer peripheral surface 25S. In the present example, the clearance between each distal end and the outer peripheral surface 25S is less than 1 mm. The distal ends may also come in contact with the outer peripheral surface 25S.

The first rib 68 is disposed within the first space 31 in the vicinity of the second space 32. The first rib 68 prevents the end portion of the connector 25 that is connected to the other connector 95 from rotating toward the bottom surface part 34. For example, if the wire 90 of the other wiring harness 9 is pulled downward in FIG. 7, the outer peripheral surface 25S of the connector 25 will abut against the first rib 68, preventing rotation of the connector 25.

The second ribs 69 are disposed at positions closer to the opening 3C than is the first rib 68. The second ribs 69 prevents the end portion of the connector 25 that is connected to the other connector 95 from rotating toward the top surface part 35. For example, if the wire 90 of the other wiring harness 9 is pulled upward in FIG. 7, the upper face of the outer peripheral surface 25S of the connector 25 abuts against the second ribs 69, preventing rotation of the connector 25.

In the present example, a stopper part 44 provided so as to approach the outer peripheral surface 25S of the connector 25 is further provided on the bottom surface part 34 of the first space 31. The stopper part 44 is, as shown in FIG. 5, a portion of the bottom surface part 34 that is located further into the first space 31 than the rail 3R. The upper surface of the stopper part 44 is flush with the upper surface of the rail 3R. The stopper part 44 is not essential. As an alternative configuration to the present example, the stopper part 44 may protrude upward.

The stopper part 44 prevents the end portion of the connector 25 that is connected to the other connector 95 from rotating toward the top surface part 35. For example, if the wire 90 of the other wiring harness 9 is pulled upward in FIG. 7, the lower surface of the outer peripheral surface 25S of the connector 25 abuts against the stopper part 44, preventing rotation of the connector 25.

Since the first rib 68, the second ribs 69, and the stopper part 44 described above prevent rotation of the connector 25, the connector 25 is not prone to looseness. Thus, the connector 25 is not prone to dropping out of the protector 3, and the connector 25 is readily maintained in the state of being held by the protector 3. If the connector 25 is held by the protector 3, the locking mechanism 29 connecting the connector 25 and the other connector 95 is unlikely to be loaded even if the vehicle vibrates, and the connection between the connector 25 and the other connector 95 is readily maintained.

Here, as alternative configurations to the present example, the protector 3 may be provided with only the first rib 68 or the second ribs 69, or only the first rib 68 and the stopper part 44, or only the second ribs 69 and the stopper part 44.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A protector including a duct-like storage space in which a wiring harness is to be disposed, comprising:
a bottom surface part, a top surface part, and a lateral surface part that form the storage space,
wherein the storage space includes:
a first space in which a connector of the wiring harness is to be disposed; and
a second space into which a wire that connects to the connector is to be inserted,
the bottom surface part forming the first space includes a rail with which the connector is to be engaged in a slidable manner, and
the top surface part forming the first space includes a rib provided to approach an outer peripheral surface of the connector that is disposed in the first space.

2. The protector according to claim 1,
wherein the first space has an opening that opens externally, and
the rib includes:
a first rib disposed in a vicinity of the second space; and
a second rib disposed at a position closer to the opening than is the first rib.

3. The protector according to claim 1,
wherein the bottom surface part forming the first space includes a stopper part provided to approach the outer peripheral surface of the connector that is disposed in the first space.

4. The protector according to claim 1, further comprising:
a main body constituted by the bottom surface part and the lateral surface part; and
a cover constituted by the top surface part and forming the second space,
wherein the cover is attachable and detachable with respect to the main body.

5. The protector according to claim 4, further comprising:
a first engaging part having a snap-fit structure and configured to engage the main body and the cover with each other.

6. The protector according to claim 4, further comprising:
a lid constituted by the top surface part and forming the first space,
wherein the lid is connected to the main body by a hinge part and is openable and closeable with respect to the main body.

7. The protector according to claim 6, further comprising:
a second engaging part having a snap-fit structure and configured to engage the main body and an end portion of the lid on an opposite side to the hinge part with each other.

8. A wiring harness routing structure comprising:
a wiring harness; and
a protector including a duct-like storage space in which the wiring harness is disposed,
wherein the protector includes a bottom surface part, a top surface part, and a lateral surface part that form the storage space,
the storage space includes:
a first space in which a connector of the wiring harness is disposed; and
a second space into which a wire that connects to the connector is inserted,
the bottom surface part forming the first space includes a rail with which the connector is engaged in a slidable manner, and
the top surface part forming the first space includes a rib provided to approach an outer peripheral surface of the connector disposed in the first space.
